(19) United States
(12) Patent Application Publication
(10) Pub. No.: US 2007/0115771 A1
(43) Pub. Date: May 24, 2007

(54) Timing recovery for channels with binary modulation

(75) Inventors: Theodorus Petrus Henricus Gerardus Jansen, Eindhoven (NL); Stek Aalbert, Eindhoven (NL); Johannes Wilhelmus Maria Bergmans, Eindhoven (NL); Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/572,157

(22) PCT Filed: Sep. 15, 2004
(86) PCT No.: PCT/IB04/51762

§ 371 Date: Mar. 16, 2006

(30) Foreign Application Priority Data
Sep. 23, 2003 (EP) 03103516.5

(51) Int. Cl. G11B 20/10

(52) U.S. Cl. 369/47.28

(57) ABSTRACT

For (re)writable and read-only optical disc systems the data clock is recovered by a phase locked loop (PLL), where the error signal is generated by comparing the actual zero-crossing with the zero-crossing of the generated clock signal. Given an optical system with a laser wavelength λₗₐₛₑᵣ and a numerical aperture NA, the cut-off wavelength of the Modulation Transfer Function is given by λ₀=λₗₐₛₑᵣ/(2·NA). With decreasing bit length the amplitude of the minimum wavelength will decrease and is zero for wavelengths below λ₀. Consequently, the phase error signals generated by zero-crossing of these signals are disturbed by noise. The idea of the invention is to use the zero-crossings with sufficient performance only in deriving phase information for the clock recovery.

This invention is related to a method of providing reliable phase error signals in a phase locked loop (PLL) in an optical system, which optical system is adapted to read data from an optical disc.

Optical discs are electronic data storage mediums that hold information in digital form and that are written and read by a laser. These discs include all the various CD, DVD and BD variations. Data are stored in so-called pits and lands (ROM disc) and marks and spaces (re-writable disc), which are read of a laser in an optical system and the data are converted into an electrical signal.

The wave length of the laser beam in an optical system used to read a DVD disc is shorter than that used for standard CDs. The DVD disc is created with shallower and smaller pits, thereby enabling greater storage capacity, which naturally is an issue of considerable importance.

In an optical system it is well known to use a phase locked loop (PLL) where the error signal is generated by comparing the actual zero-crossing with the zero-crossing of the generated clock signal. Given an optical system with a laser wavelength λₗₐₛₑᵣ and an numerical aperture NA, the cut-off wavelength of the Modulation Transfer Function (MTF) is given by λ₀=λₗₐₛₑᵣ/(2·NA). The minimum wavelength on the optical disc is determined by the minimum bit length on the optical disc, and with decreasing bit length on the optical disc as a result of larger storage capacities on the optical discs, the amplitude of the signal read by means of an optical system will decrease and will be zero for wavelengths below λ₀.

Consequently, the phase error signals generated by zero-crossing of these signals are determined by noise and are therefore inapplicable. It is thus a problem in the state of the art to increase the capacity of optical discs by decreasing the bit length on the discs and at the same time being able to generate reliable phase error signals in the phase locked loop of the optical system reading from and/or writing to the optical disc.

It should be noted, that the MTF in general is a function that is defined as the modulation of an image divided by the modulation of the object and that MTF thus is a function of the spatial frequency of the image, where the image in this case is the bit pattern on the optical disc. When the wavelength of the bit pattern decreases, the MTF goes towards zero and is zero at the so-called cut-off frequency corresponding to the cut-off wavelength, which is mentioned above.

It is thus an object of the invention to procure a method of providing reliable phase error signals in a phase locked loop in an optical system, which optical system is adapted to read data from an optical disc, said method comprising the steps of reading a bit pattern on the optical disc, thereby providing a plurality of signal samples; feeding the signal samples to a phase detector in the phase locked loop; and using a changing of polarity of successive signal samples, a so-called zero crossing, in the phase detector to generate a phase error signal for the phase locked loop. The method is characterized in that the phase detector is adapted to take into account the polarity of a number of signal samples before and after a zero crossing to derive a reliable phase error signal so that the influence of noise is reduced.

Hereby, it is possible to provide reliable phase error detection even in optical systems wherein the smallest wavelength on the optical disc is close to or even smaller than the cut-off wavelength of the MTF associated with the optical system. This makes it possible to store bits with a smaller bit length and thereby an increased amount of bits on an optical disc.

In a preferred embodiment of the method according to the invention, the quality of the zero-crossings depends on the signal samples before and after the zero-crossing. Hereby, the usage of a zero-crossing is limited to the cases, where quality is sufficient. For instance, in reading bit patterns having spatial frequencies far under the cut off frequency of the MTF, the amplitude of signal samples is large and the zero-crossing is reliable. Reading bit patterns with spatial frequencies close to or larger than the cut off frequency the signal amplitudes will be small and the position of the zero-crossing will be unreliable.

The term “quality of the zero-crossings” includes features such as the amplitude of the signal samples before and after the zero-crossing, the signal-to-noise-ratio of the signal samples and the size of the marks in the bit pattern read.

It should be noted, that the frequency and the wavelength of a signal are inversely proportional, so that a signal having a frequency above the cut-off frequency has a wavelength below the cut-off wavelength and vice versa.

In a preferred embodiment of the method according to the invention, the data on the optical disc are stored in Run Length Limited (RLL (d)) encoding with a constraint d being the run length (i.e. the minimum spacing between polarity changes on the disc is equal to d+1). Run Length Limited encoding is an advanced family of coding techniques, which are currently used in all types of optical disc. When the method according to the invention is used with disc whereon the data are stored in RLL encoding, the increased disc capacity provided by the method of the invention is combined with the encoding technique currently most frequently used.

In yet another preferred embodiment of the method according to the invention, the phase detector is adapted to take into account the polarity of n signal samples before and after a zero crossing, where n satisfies the condition: n≧d+2. This provides an easily realizable guideline for the number of signal samples to be used in the generation of reliable phase error signals.

These and other aspects of the invention will be apparent from and elucidated with reference to the embodiments described hereinafter.

The invention will be described in more details in connection with the attached figures, wherein:

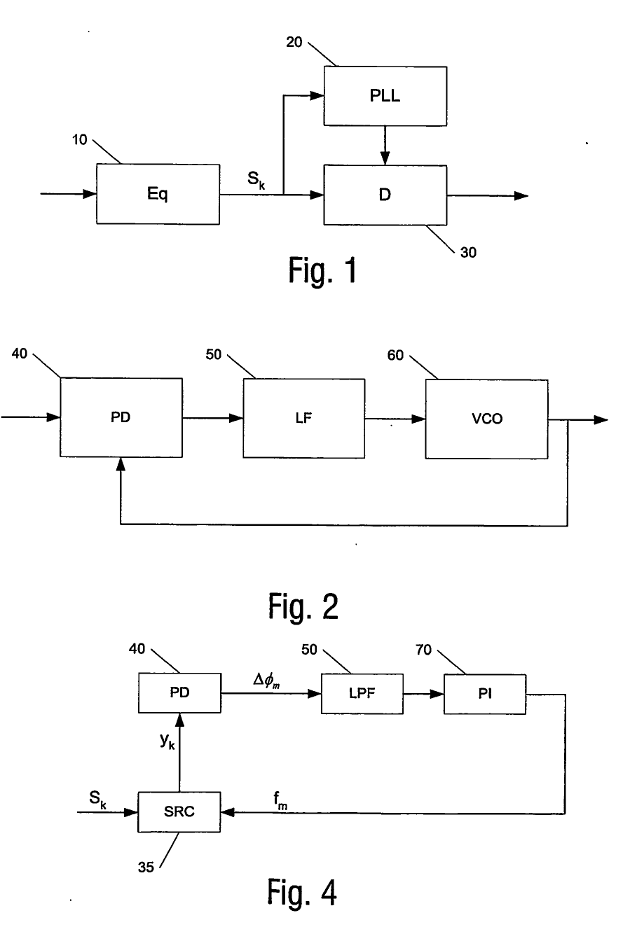

FIG. 1 is a diagram of a general concept for bit detection (prior art);

FIG. 2 is a diagram of a common phase locked loop (prior art);

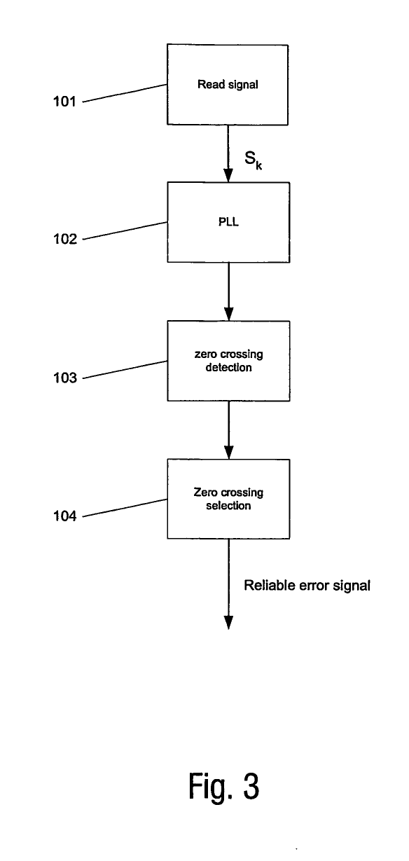

FIG. 3 is a flow diagram of the method according to the invention;

FIG. 4 shows a phase locked loop structure, which is equivalent to the structure in FIG. 3 and which is to be used to incorporate the method according to the invention;

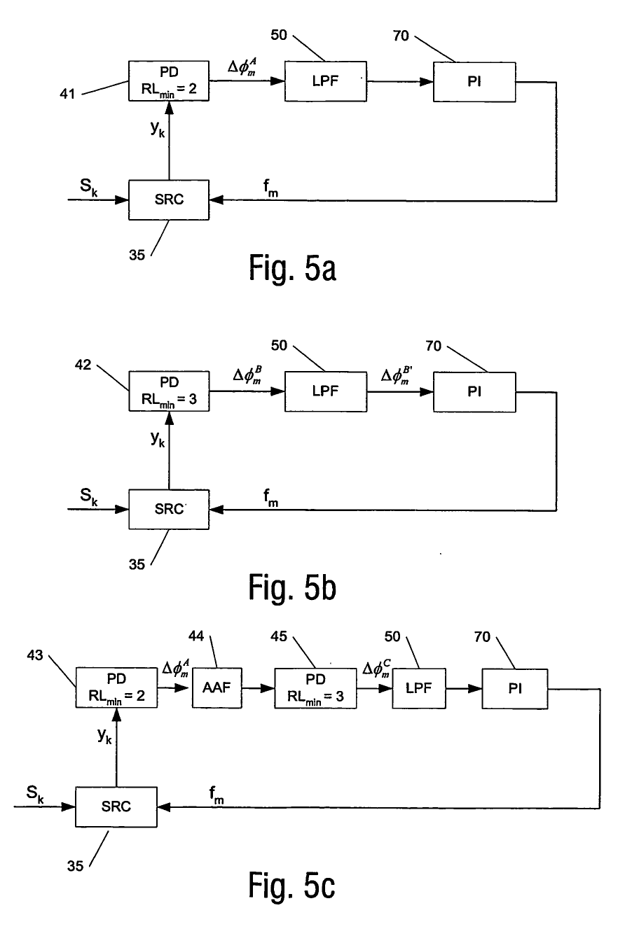

FIGS. 5a-5c show phase locked loop structures incorporating the method according to the invention;

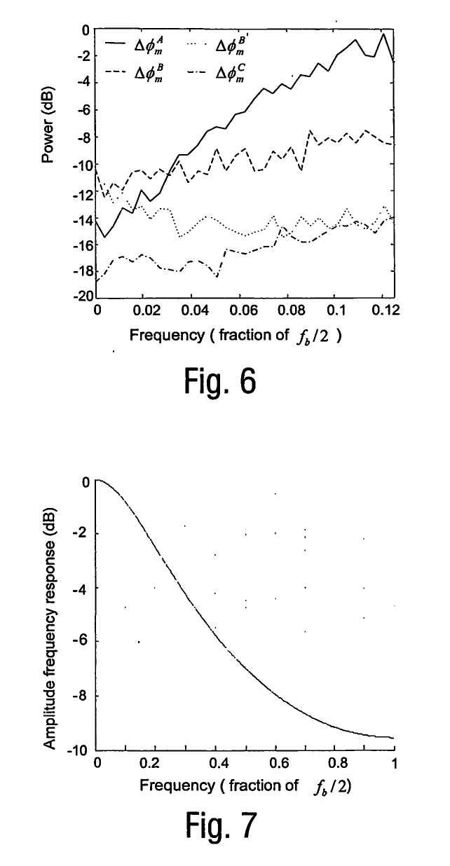

FIG. 6 shows spectra of detected phase errors due to inter-symbol interference (ISI);

FIG. 7 shows an amplitude frequency response of an anti-aliasing filter;

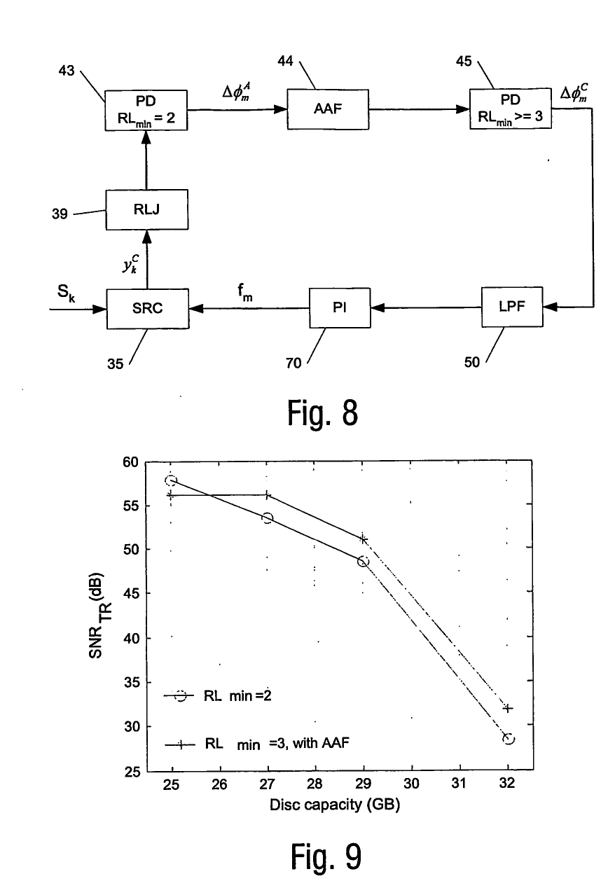

FIG. 8 shows an embodiment of a timing recovery circuit for incorporating the method according to the invention; and

FIG. 9 shows the SNR_{TR} values of the structures in FIGS. 5a and 5c.

FIG. 1 is a diagram of a general concept for bit detection (prior art) on a disc containing bits coded in binary modulation coding. The pits and lands on the disc (for Read Only Media ROM) or the marks and spaces (for rewritable media) are read by a reading means, i.e. a laser, in an optical system, when the disc is played. Based on its length, each pit/mark is interpreted as a sequence of zeroes, and, based on its length, each land/space is interpreted as a sequence of ones. The signal from the reading means in the optical system arranged to read the rewritable and/or read-only discs is fed to an equaliser 10 and therefrom to an Phase Locked Loop 20 as well as to a detector, e.g. a Viterbi detector 30. An example of a Phase Locked Loop 20 is shown in FIG. 2, which shows common well-known phase locked loop.

The Phase Locked Loop 20 comprises a Phase Detector 40, a Loop Filter 50 and an oscillator 60, e.g. a Voltage Controlled Oscillator. The phase detector 40 compares the phase of the output signal to the phase of a reference signal. If there is a phase difference between the two signals, the phase detector 40 generates an output voltage, which is proportional to the phase error between the two signals. This output voltage passes through the loop filter and then as an input to the voltage controlled oscillator (VCO) controls the output frequency. Due to this self correcting technique, the output signal will be in phase with the reference signal. When the two signals are synchronized, the phase error between the two signals is zero or almost zero.

FIG. 3 is a flow diagram of the method according to the invention. In step 101 the bit pattern from an optical disc is read, thereby providing a plurality of signal samples Sₖ. These samples Sₖ are fed to a first phase detector in a phase locked loop, step 102. In step 103, the Phase Locked Loop detects zero crossings in the stream of signal samples Sₖ. In step 104, an operation is performed to ensure that a reliable zero crossing is selected. One possible; way can be that the zero crossings are chosen, which are preceded by at least n positive samples and followed by at least n negative samples.

The number, n, preferably depends on the performance of the signals. Thus the method according to the invention only uses zero crossings with a sufficient performance for deriving phase information for the timing recovery in the Phase Locked Loop and therefore step 104 results in a reliable error signal.

FIG. 4 shows a phase locked loop structure, which is equivalent to the structure in FIG. 3 and which is to be used to incorporate the method according to the invention. The phase locked loop structure is a second order phase locked loop consisting of a Phase Detector (PD) 40, a Low-Pass Filter (LPF) 50 and a PI control part 70 as well as a Sample Rate Converter (SRC) 35. Sₖ and yₖ denote the data samples before and after the Sample Rate Converter 35. The data samples Sₖ are asynchronous and the data samples Yₖ are synchronous. The deviation of the signal Yₖ from Sₖ results only from the timing recovery.

The output from the Phase Detector, Δφₘ, is the phase error signal. In case of RLL codes, the phase information of the data sequence yₖ can be acquired by the equation: φₘ=yₘ/(yₘ−yₘ₊₁), where m and m+1 denote two sampling moments around a zero crossing. For a synchronously sampled sequence (i.e. with ideal bit detection moments), the value of φₘ equals 0.5 (on average), and therefore the phase error signal can be expressed by the equation:
Δφₘ=φₘ−0.5.

The phase error signals usually suffer from noise and inter-symbol interference (ISI). As a result, after the PLL has settled down, i.e. the PLL is in the lock condition, the sample frequency fₘ can fluctuate around a certain value, which leads to non-ideal sampling moments. The higher storage density on an optical disc, the stronger ISI, due to narrowed mark/pit length. Thus the idea of the method according to the invention is to ignore the phase information extracted from the zero crossings that involve short run lengths (e.g. d=1 and d=2 in a Run Length Limited (RLL) encoding with a run length d+1). Thus some phase error pre-processing steps are introduced, which will be explained below in relation to FIGS. 5-9.

FIGS. 5a-5c show phase locked loop structures incorporating the method according to the invention in the case of RLL (d=1) code. In FIG. 5a the phase locked loop structure comprises a phase detector 41 configured to only take into account those zero crossing preceded and followed by run lengths equal to or greater than 2 (RLₘᵢₙ expresses the shortest run length involved in the phase detection, so e.g. “RLₘᵢₙ=3” means, that the zero crossings preceded and/or followed by run length 2 are skipped). The output of the phase detector 41 is denoted Δφₘ^{A}. The remaining structural elements of the Phase Locked Loop structure shown in FIG. 5a correspond to those shown in FIG. 4. In FIG. 5b the phase locked loop structure comprises a phase detector 42 configured to only take into account those zero crossing preceded and followed by run lengths equal to or greater than 3. The output of the phase detector 42 is denoted Δφₘ^{B} and is fed to the Low-Pass Filter 50 whereof the output signal is denoted Δφₘ^{B′}. The remaining structural elements of the Phase Locked Loop structure shown in FIG. 5b correspond to those shown in FIG. 4.

FIG. 5c shows a phase locked loop structure incorporating a preferred embodiment of the method according to the invention. The Phase Locked Loop structure comprises a first phase detector 43 configured to only take into account those zero crossing preceded and followed by run lengths equal to or greater than 2, an Anti-Aliasing Filter 44 and a second Phase Detector 45 configured to only take into account those zero crossing preceded and followed by run lengths equal to or greater than 3. The output of the first phase detector 43 is denoted Δφₘ^{A} and the output of the second Phase Detector 45 is denoted Δφₘ^{C}. The remaining structural elements of the Phase Locked Loop structure shown in FIG. 5c correspond to those shown in FIG. 4.

FIG. 6 shows spectra of detected phase errors due to ISI in case of a 27 GB blu-ray disc with synthetic synchronous data samples without noise as the input Sₖ of the PLL. The spectra of the outputs from the Phase Detectors in FIGS. 5a-5c, Δφₘ^{A}, Δφₘ^{B}, Δφₘ^{B′} and Δφₘ^{C}, are shown. These spectra reflect the disturbance to timing recovery due to ISI. It can be seen, that the low frequency components of A₄^{C} are effectively depressed as desired; however, this is not the case for Δφₘ^{B}. This implies that the anti-aliasing filter, FIG. 5c, plays an important role.

FIG. 7 shows the amplitude frequency response of the anti-aliasing filter 44 (FIG. 5c). The anti-aliasing filter 44 is a first-order IIR low-pas filter.

FIG. 8 shows an embodiment of a timing recovery circuit for incorporating the method according to the invention. The timing recovery circuit resembles the circuit shown in FIG. 5c, in that the circuit shown in FIG. 8 also comprises a Sample Rate Converter 35, a first Phase Detector 43, an Anti-Aliasing Filter 44, a second Phase Detector 45, a Low-pass Filter 50 and a PI control unit 70. However, the circuit shown in FIG. 8 further comprises a run length judgement element 39, the function of which is explained below. It should be noted, that the ignored short run length in the Phase Detector 45 is generalized to run lengths longer or equal to 3. This reduces the impact of ISI on the zero crossings further at the cost of some percentage of timing information loss.

In order to evaluate the timing recovery, a signal-to-noise ratio SNR_{TR} is determined by:

$${SNR}_{TR} = 20 log \frac{‖ {s}_{k} ‖}{‖ {y}_{k}^{L} - {s}_{k} ‖} , L = A , B , C$$

Since the incoming sample sequence Sₖ is synchronous and noise free, SNR_{TR} indicates the robustness of the timing recovery scheme against ISI. SNR_{TR} have been measured for the Phase Locked Loops in FIGS. 5a and 5c for four disc capacities, viz. 25 GB, 27 GB, 29 GB and 32 GB. The latter two capacities are based on the blu-ray disc system with reduced channel bit-length. FIG. 9 shows the SNR_{TR} values of the structures in FIGS. 5a and 5c and illustrates that the loop shown in FIG. 5c is superior to that shown in FIG. 5a. When the disc capacity is enhanced, the frequency of the short run length pattern approaches or even exceeds the cut-off frequency of the optical system, and zero-crossings involving these short run lengths will disappear. As a result, the decision on run lengths becomes difficult, and as a result hereof an extra run length judgement element is added to the loop shown in FIG. 5c, as explained above and shown in FIG. 8.

1. A method of providing reliable phase error signals in a phase locked loop (20) in an optical system, which optical system is adapted to read data from an optical disc, said method comprising the steps of:
reading a bit pattern on the optical disc, thereby providing a plurality of signal samples (Sk),
feeding the signal samples (Sk) to a first phase detector (40, 41, 42, 43) in the phase locked loop (20),
using a changing of polarity of successive signal samples (Sk), a so-called zero crossing, in the first phase detector to generate a phase error signal for the phase locked loop (20), characterized in that
the first phase detector (40, 41, 42, 43) is adapted to take into account the polarity of a number of signal samples (Sk) before and after a zero crossing to derive a reliable phase error signal so that the influence of noise and Inter Symbol Interference (ISI) is reduced.

2. A method according to claim 1, characterized in that the number of signal samples (Sk) used before and after a zero crossing depends on the quality of the signal samples (Sk).

3. A method according to claim 1, characterized in that the data on the optical disc are stored in Binary Modulation (BM).

4. A method according to claim 1, characterized in that the first phase detector (40, 41, 42, 43) is adapted to take into account only those changes of the polarity which are preceded by at least n signal samples with identical polarity and which are succeeded by at least n signal samples with the opposite polarity.

5. A method according to claim 1, characterized in that the data on the optical disc are stored in Run Length Limited (RLL (d)) encoding with a constraint d being the run length.

6. A method according to claim 5, characterized in that the first phase detector (40, 41, 42, 43) is adapted to take into account only those changes of the polarity which are preceded by at least n signal samples with identical polarity and which are succeeded by at least n signal samples with the opposite polarity, where n satisfies the condition: n≧d+2.

7. A method according to claim 6, characterized in that the data on the optical disc are stored in RLL (d=1 encoding.

8. A method according to claim 4, characterized in that the method further comprises:
feeding the signal from the first phase detector (43) to an Anti-Aliasing Filter (44) and subsequently to a second phase detector (45).

9. A method according to claim 8, characterized in that, the first phase detector (43) takes signal samples, where the minimum run length is 2 into account only, and the second phase detector (44) takes signal samples, where the run length is equal to or greater than 3 into account only.

10. A system for performing the method according to claim 1.

11. An apparatus for writing bit patterns on an optical disc to be read in by use of method according to claim 1.

12. A disc whereon bit patterns are written to be read by use of the method according to claim 1.
